(19) United States
(12) Patent Application Publication
(10) Pub. No.: US 2012/0144389 A1
(43) Pub. Date: Jun. 7, 2012

(54) OPTIMIZING VIRTUAL IMAGE DEPLOYMENT FOR HARDWARE ARCHITECTURE AND RESOURCES

(75) Inventors: Tyler C. Hicks, Wichita, KS (US); Yoojin Kwak, Pittsburg, PA (US); Prosun Niyogi, Austin, TX (US); Michael A. Smith, Austin, TX (US); Mark W. VanderWiele, Austin, TX (US)

(73) Assignee: International Business Machines Corporation, Armonk, NY (US)

(21) Appl. No.: 12/962,181

(22) Filed: Dec. 7, 2010

(51) Int. Cl. G06F 9/455; G06F 15/16

(52) U.S. Cl. 718/1

(57) ABSTRACT

A method of optimally deploying virtual images in a system of servers having different architectures and resources automatically deploys a first virtual image to each of a plurality of servers in the heterogeneous system of servers. The method monitors performance of the first virtual image on each of the servers. The method calculates a quality of service metric for the first virtual image on each server. The method ranks the servers in terms of said quality of service metric for the first virtual image. The method automatically deploys the first virtual image to a highest ranked server in terms of quality of service metric for the first virtual image.

### BACKGROUND

1. Technical Field

Embodiments of the present invention relates generally to the field of data center management, and more particularly to methods, systems, and program products for optimally deploying virtual images in a data center comprising servers having heterogeneous hardware architectures and resources.

2. Description of Related Art

A logical partition (LPAR) is the division of a computer's processors, memory, storage, and input/output into multiple sets of resources so that each set of resources can be operated independently with its own operating system instance and applications. The number of logical partitions that can be created depends on the system's processor model and resources available. Typically, partitions are used for different purposes such as database operations or client/server operations or to separate test and production environments. Each LPAR can communicate with the other LPARs as if the other LPAR were a separate machine. Logical partitioning allows the computer's resources to be used more efficiently.

Recently, virtualization technology has been expanded with workload partitions (WPARs). WPAR technology allows administrators to virtualize their operating system, which allows for fewer operating system images on a partitioned server. Prior to WPARs, an administrator would need to create a new LPAR for each new isolated environment. Every LPAR requires its own operating system image and a certain number of physical resources.

WPARs are simpler to manage than LPARs. A shortcoming of LPARs is the need to maintain multiple operating system images, which may lead to over-committing expensive hardware resources. While partitioning helps to consolidate and virtualize hardware within a physical machine, operating system virtualization through WPAR technology goes further and allows for an even more granular approach to resource management.

LPARs and WPARs may be collectively referred to as virtual images. Currently, there is no method of deploying virtual images in a way that is optimized for hardware architecture. For example, certain images may perform better on a virtual partition on an IBM® zSeries® server than on an IBM® xSeries® server, or vice versa, but there is no way to discover this.

### BRIEF SUMMARY

Embodiments of the present invention provide methods, systems, and computer program products for optimally deploying a virtual image in a system of servers having different architectures and resources. A method according to one embodiment of the present invention automatically deploys a first virtual image to each of a plurality of servers in a heterogeneous system of servers. The method monitors performance of the first virtual image on each the servers. The method calculates a quality of service metric for the first virtual image on each server. The method ranks the servers in terms of the quality of service metric for the first virtual image. The method automatically redeploys the first virtual image to a highest ranked server in terms of quality of service metric for the first virtual image.

In some embodiments, the method examines outgoing network traffic from the first virtual image to recipient images deployed on servers throughout the system. The method ranks the recipient images in terms of network traffic from the first virtual image. The method automatically deploys the recipient image ranked highest, in terms of network traffic, to a server located physically nearest the server upon which the first virtual image is deployed. In some embodiments, the method determines if the server to which the first virtual image is deployed is optimal for the highest ranked recipient image. If the server to which the first virtual image is deployed is optimal for the highest ranked recipient image, the method deploys the highest ranked recipient image to the same server to which the first virtual image is deployed.

In other embodiments, the first virtual image has a range of quality of service metric values from a maximum value to a minimum value. An embodiment of the method determines a number of servers to which the first virtual image has been deployed where the quality of service metric is greater than the maximum value. If the quality of service metric is greater than the maximum value on more than a preselected number of servers, the embodiment automatically reduces the resources allocated to the first virtual image on the server to which the first virtual image is deployed.

In still other embodiments, the method monitors performance of the first virtual image over different date and time periods. The method uses quality of service information for the first virtual image to forecast periods in which the quality of service for the first virtual image will fall below a predetermined threshold. The method automatically deploys additional instances of the first virtual image in anticipation of forecasted periods in which the quality of service for the first virtual image will fall below the predetermined threshold.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a flowchart of an embodiment of intelligent pairing of images to servers for optimal deployment according to the present invention;

FIG. 3 is a flowchart of an embodiment of automatic collocation of dependent images according to the present invention;

FIG. 4 is a flowchart of an embodiment of automatic intelligent image resource reallocation according to the present invention;

FIGS. 5A-B are flowcharts of an embodiment of demand forecasting according to the present invention;

FIG. 6 is a block diagram of a server computing device in which features of the present invention may be implemented; and,

FIG. 7 is a block diagram illustrating a data processing system in which a management console according the present invention may be implemented.

### DETAILED DESCRIPTION OF THE PREFERRED EMBODIMENT

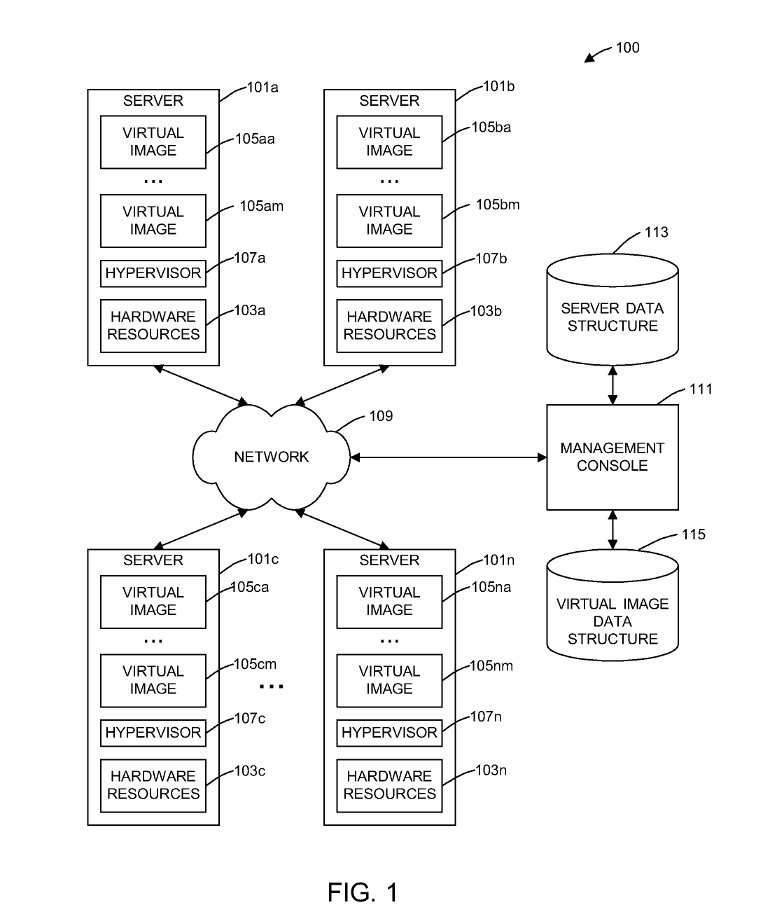

Referring now to the drawings, and first to FIG. 1, an embodiment of a system according to the present invention is designated generally by the numeral 100. System 100 includes a plurality of servers 101. Each server 101 includes a set of hardware resources, indicated generally at 103. Hardware resources include processors, memory, network adapters, and the like. System 100 is heterogeneous in the sense that servers 101 may be built by different manufacturers, have different processors and other resources.

Each server 101 is a capable of virtualization, having installed thereon one or more virtual images 105. Virtual images 105 may be logical partitions (LPARs) or workload partitions (WPARs). An LPAR is a division of the resources 103 of host system 101 into a set of resources so that each set of resources can be operated independently with its own operating system instance and application or applications. An LPAR may include one or more WPARs. A WPAR is a further division of the resources 103 of host system 101 into a set of resources such that each set of resources can be operated independently with its own virtualized operating system image and applications. Inside a WPAR, the application or applications have private execution environments that are isolated from other processes outside the WPAR. Virtual images may be dynamically relocated from one server 101 to another server 101.

Host system 101 includes a hypervisor 107. Hypervisor 107 provides the foundation for virtualization of host server 101. Hypervisor 107 enables the hardware resources 103 of host server 101 to be divided into the multiple virtual images 105 and it ensures strong isolation between them. Hypervisor 107 is responsible for dispatching the virtual image 105 workloads across the physical processors. Hypervisor 107 also enforces partition security and it can provide inter-partition communication among virtual images 105 hosted on the same host server 101.

Servers 101 are interconnected through a network, indicated generally at 109. Network 109 may comprise a local area network (LAN), a wide area network (WAN) or a system of interconnected networks. System 100 may be a relatively small installation of servers 101 located in a single room or building, or a larger installation of servers 101 located on a campus, or a very large installation of servers 101 located across the country or the world. The configuration of network 109 depends on the size and extent of system 100.

System 100 includes a management console 111. Management console 111 may be implemented in any suitable computer coupled to network 109. Management console 111 provides a user interface to a system administrator and it is programmed to perform virtual image deployment optimization according to the present invention. Management console 111 controls resources allocated to each virtual image 105. As will be described in detail hereinafter, management console 111 automatically deploys virtual images 105 to different servers 101 and monitors the performance of deployed virtual images 105 on the various servers 101. Management console 111 analyzes performance data to deploy virtual images optimally throughout system 100.

Management console 111 maintains a server data structure 113. Server data structure 113 maintains information for each server 101 including, among other things, the server's host name, resources, physical location of the server, and a current performance ranking for each virtual image. Management console 111 also maintains a virtual image data structure 115. Virtual image data structure maintains information for each virtual image 105 including, among other things, the host architecture upon which the virtual image executes, a range of acceptable quality of service (QoS) metrics for the virtual image, system resource requirements for the image, and a list of possible servers to which the image may be deployed. When a virtual image 105 is added to system 100, an administrator specifies the QoS range, system resource requirements, and the supported architectures for the virtual image.

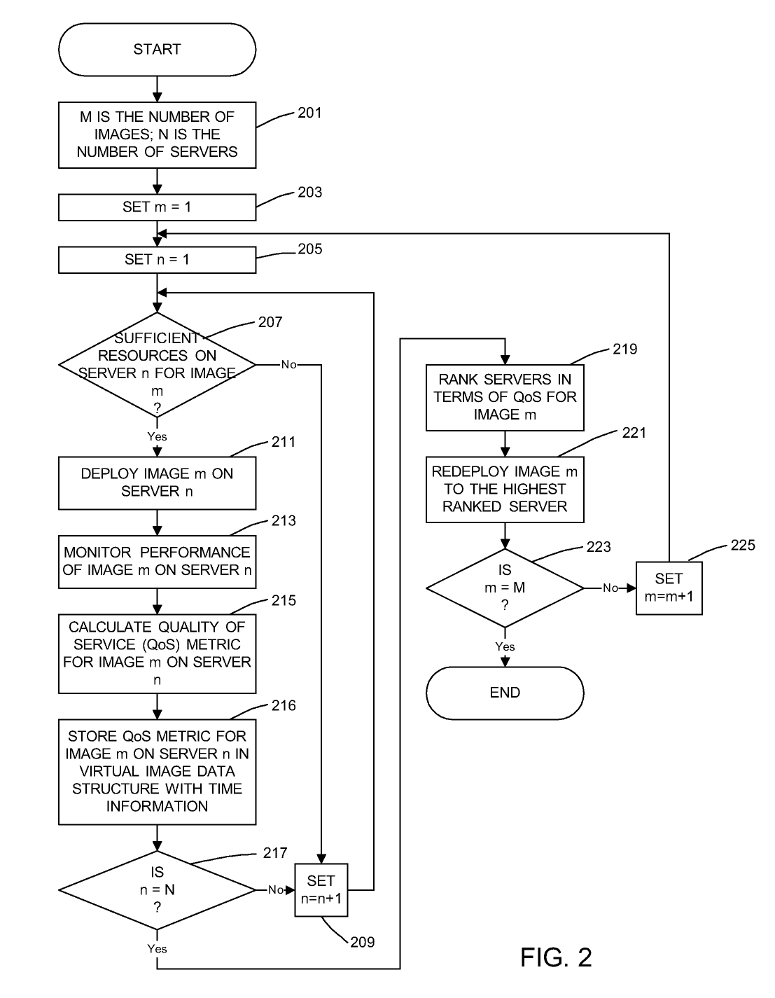

FIG. 2 is a flowchart of an embodiment of intelligent pairing of images to servers for optimal deployment according to the present invention. At block 201, a constant M is set equal to the number of virtual images to be deployed and a constant N is set to the number servers to which the virtual images are to be deployed. Then m is set equal to 1, at block 203, and n is set equal to 1, at block 205. Management console 111 determines, at decision block 207, if there are sufficient resources on server n to run virtual image m. If there are not sufficient resources on server n to run virtual image m, the system sets n equal to n+1, at block 209, and processing returns to decision block 207. If, as determined at decision block 207, there are sufficient resources on server n for image m, management console 111 automatically deploys virtual image m to server n, as indicated at block 211. Management console 111 then monitors the performance of virtual image m on server n for a preselected time period, as indicated at block 213. Examples of performance criteria that may be monitored include processor load, memory consumption, network saturation, and disk I/O. The list of performance criteria is dynamic and it may be tailored to a specific workload.

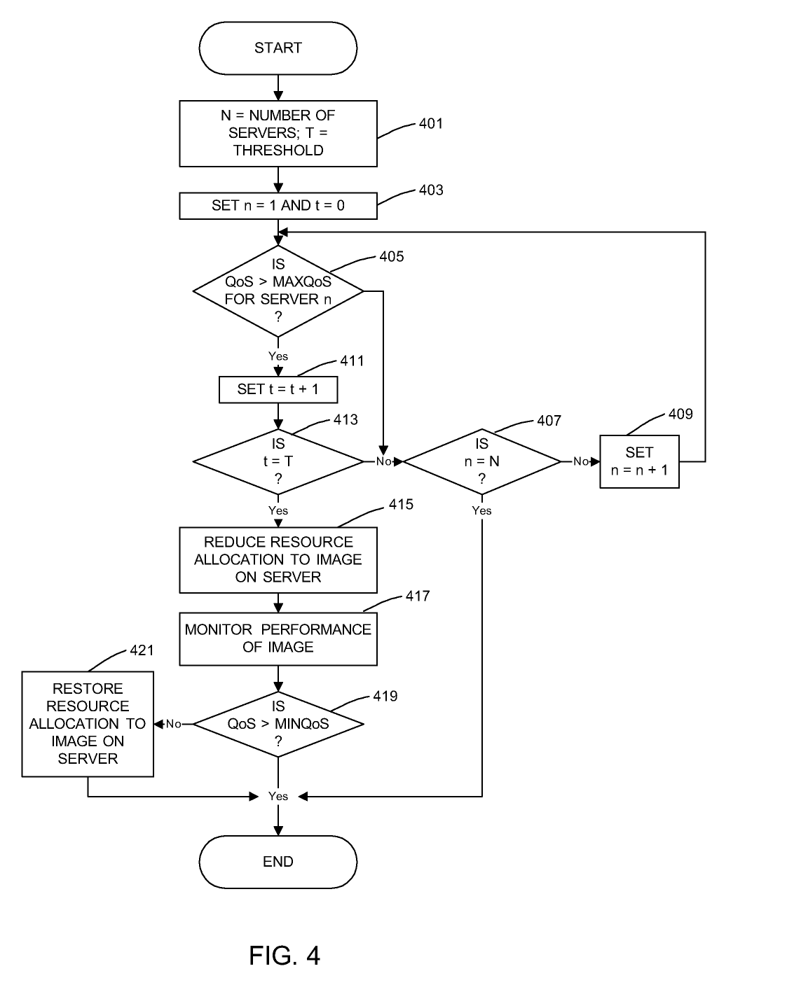

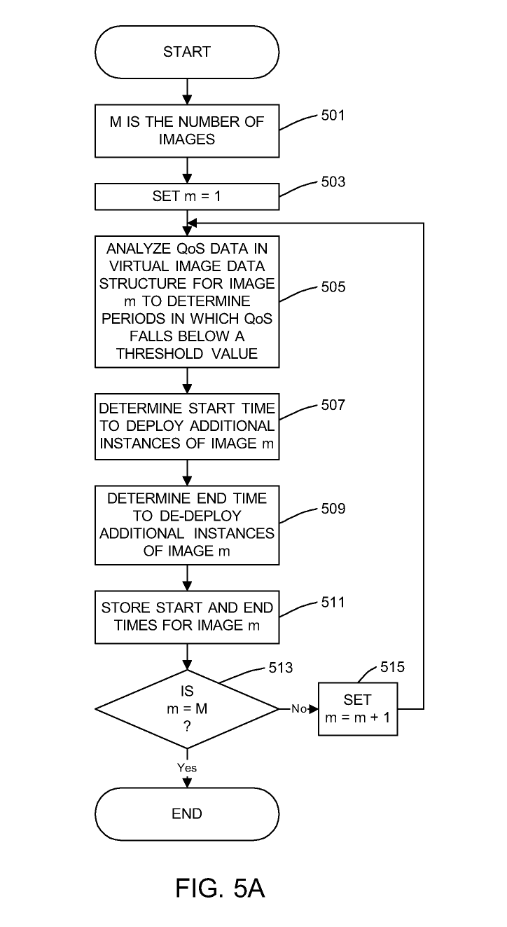

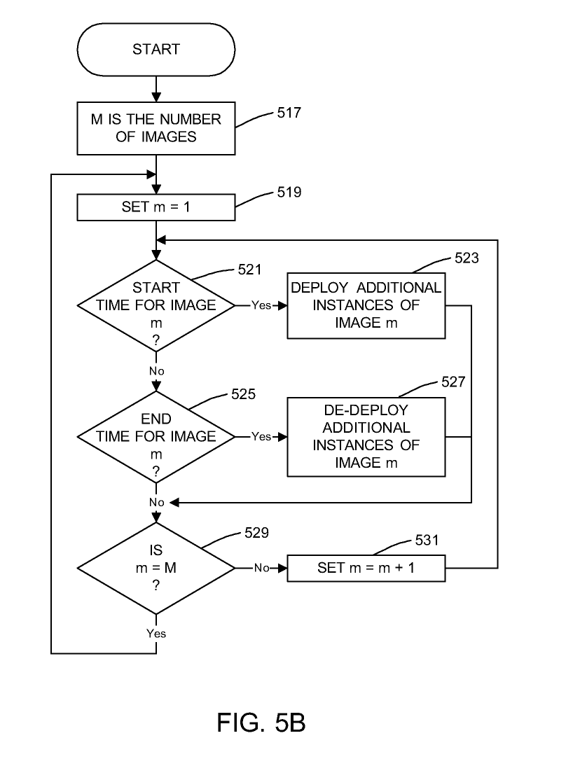

After monitoring the performance of virtual image m on server n, management console 111 calculates a QoS metric for virtual image m on server n, at block 215. After calculating the QoS metric for virtual image m on server n, management console 111 stores the stores the calculated QoS metric for virtual image m on server n with time information in virtual image data structure 115 of FIG. 1, as indicated at block 216. Then, management console 111 determines if n is equal to N, at decision block 217. If n is not equal to N, which means that there are more servers, management console 111 sets n=n+1, at block 209, and processing returns to decision block 207. If, as determined at decision block 217, n is equal N, which means that image m has been deployed to all servers, management console 111 ranks the servers in terms of QoS for image m, at block 219. Then, management console 111 automatically redeploys image m to the highest ranked server, at block 221. Then, management console 111 determines, at decision block 223, if m is equal to M. If m is not equal to M, management console 111 sets m=m+1, at block 225, and processing returns to block 205. If, as determined at decision block 223, m is equal M, which means that all images have been deployed, intelligent optimal pairing of image to server processing ends. Processing according to FIG. 2 may be performed periodically so as to build up information that may be used to optimized system 100 further, as will be discussed in detail with reference to FIGS. 4 and 5.

In the embodiment of FIG. 2, management console 111 deploys the virtual images to the various servers of system 100 one at a time, in serial fashion. It should be recognized that in alternative embodiments, multiple copies of a virtual image may be deployed simultaneously to multiple servers, in parallel fashion. It should further be recognized that in other alternative embodiments, management console 111 may deploy different virtual images at the same time to the same server, again in parallel fashion.

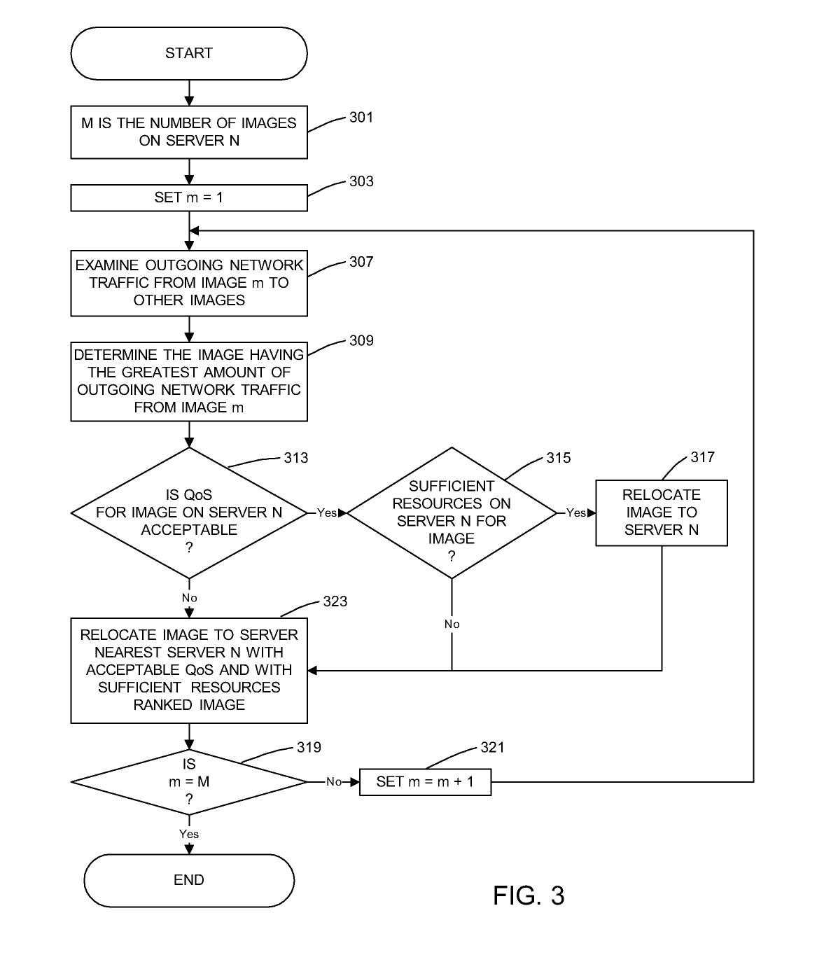

In another aspect of the present invention, management console 111 collocates dependent virtual images within system 100. FIG. 3 is a flowchart of an embodiment of automatic collocation of dependent images according to the present invention. The process of FIG. 3 is initialized, at block 301, by setting the constant M equal to the number of images on a server N. Management console 111 sets m equal to 1, at block 303, and the system monitors outgoing network traffic from image m, at block 307. In some embodiments, a daemon running on server N may monitor network traffic in each physical and virtual network port. Management console 111 determines the image having the greatest amount of network traffic from image m, at block 309. Then, management console 111 determines, at decision block 313, if the QoS metric for the image having the greatest amount of network traffic from image m is acceptable on server N. The QoS metrics for all images on all servers was calculated during processing according to FIG. 2. If the QoS metric for the image having the greatest amount of network traffic from image m is acceptable on server N, management console 111 determines, at decision block 315, there are sufficient currently available free resources on server N for the highest ranked image. If there are sufficient currently available free resources on server N for the image having the greatest amount of network traffic from image m, management console 111 relocates the image having the greatest amount of network traffic from image m to server N, at block 317. Then, management console 111 determines, at decision block 319, if m is equal to M. If m is not equal to M, management console 111 sets m equal to m+1, at block 321, and processing returns to block 307. If, as determined at decision block 315, that there are not sufficient currently available resources on server N for the image having the greatest amount of network traffic from image m, or, as determined at decision block 313, that the image having the greatest amount of network traffic from image m does not have an acceptable QoS on server N, management console 111 relocates the image having the greatest amount of network traffic from image m to a server nearest to server N that provides an acceptable QoS and has sufficient currently available resources for the image having the greatest amount of network traffic from image m. FIG. 3 processing continues until all images on server N have been paired with a dependent image. The system may repeat the process of FIG. 3 for all servers in the network.

The QoS metric information collected during processing according to the embodiment of FIG. 2 and stored in virtual image data structure 115 can be used to optimize system 100 further. For example, in another of its aspects, embodiments of the present invention provide automatic tuning of resources allocated on a server to a virtual image when the QoS calculated for a virtual image on a preselected number of servers exceeds the maximum QoS metric for the virtual image. FIG. 4 is a flowchart of an embodiment of automatic intelligent image resource reallocation according to the present invention. The process is initialized at block 401 by setting the constant N equal to the number of servers to which a virtual image has been deployed. Management console 111 sets a constant T equal to a threshold value for the number or percentage of servers on which the virtual image exceeds its maximum QoS metric value. Then, the process sets n equal to 1 and t equal to 0, at block 403. The process determines, at decision block 405, the QoS is greater than the maximum QoS for the virtual image on server n. If the QoS is not greater than the maximum QoS for the virtual image on server n, the process determines, at decision block 407, if n is equal to N. If not, the process sets n equal to n+1, at block 409, and returns to decision block 405. If, as determined at decision block 407, n is equal to N, processing ends.

Returning to decision block 405, if the QoS is greater than the maximum QoS for the virtual image on server n the process sets t equal to t+1, at block 411, and determines, at decision block 413, if t is equal T. If t is not equal to T, processing continues to block 407. If t is equal to T, which indicates that the QoS metric exceed the maximum on the threshold number of servers, management console 111 automatically reduces that resource allocation to the virtual image on the server to which it is deployed, at block 415. The deallocated resources may be placed in an inactive pool rather than being immediately allocated to other virtual images running on the server. Management console 111 then monitors the performance of the image, at block 417. If, as determined at decision block 419, after reduction of resources allocated to the virtual image, the QoS value for the virtual image on the server to which the virtual image is deployed is greater than a minimum value set for the virtual image, processing end. If the reduction of resources results in a degradation of performance below the minimum QoS value on the server to which the virtual image is deployed, management console 111 restores the deallocated resources to the virtual image, at block 421.

In yet another of its aspects, embodiments of the present invention perform demand forecasting and automatic deployment of additional instances of virtual images based on forecasted demand. FIGS. 5A and 5B are high level flowcharts of embodiments of demand forecasting and deployment according to the present invention. Referring first to FIG. 5A, management console 111 sets a constant M equal to the number of images, at block 501. Then management console 111 sets m equal to 1, at block 503. Management console 111 then analyzes the QoS data stored in virtual image data structure 115 to determine periods, if any, in which the QoS calculated for image m falls below a predetermined threshold value, as indicated at block 505. Management console 111 determines a start time at which to deploy additional instances of image m, at block 507, and an end time at which to de-deploy additional instances of image m, at block 509. Management console 111 then stores the start and end times for image m in virtual image data structure 115, as indicated at block 511. Management console 111 determines, at decision block 513, if m is equal to M. If m is not equal to M, management console 111 sets m equal to m plus one, at block 515, and processing returns to block 505. If, as determined at decision block 513, m is equal M, processing ends.

Referring now to FIG. 5B, management console 111 set the constant M equal to the number of images, at block 517, and sets m equal to one, at block 519. Management console 111 then determines, at decision block 521, if the current time is the start time for image m. If the current time is the start time for image m, management console 111 deploys additional instances of image m, as indicated at block 523. If the current time is not the start time for image m, management console 111 determines, at decision block 525, if the current time is the end time for image m. If the current time is the end time for image m, management console 111 de-deploys the additional instances of image m, as indicated at block 527. If the current time is not the end time for image m, management console 529 determines, at decision block 529, if m is equal to M. If m is not equal M, management console 111 sets m equal to m plus one, at block 531, and processing returns to decision block 521. If m is equal M, processing returns to block 519.

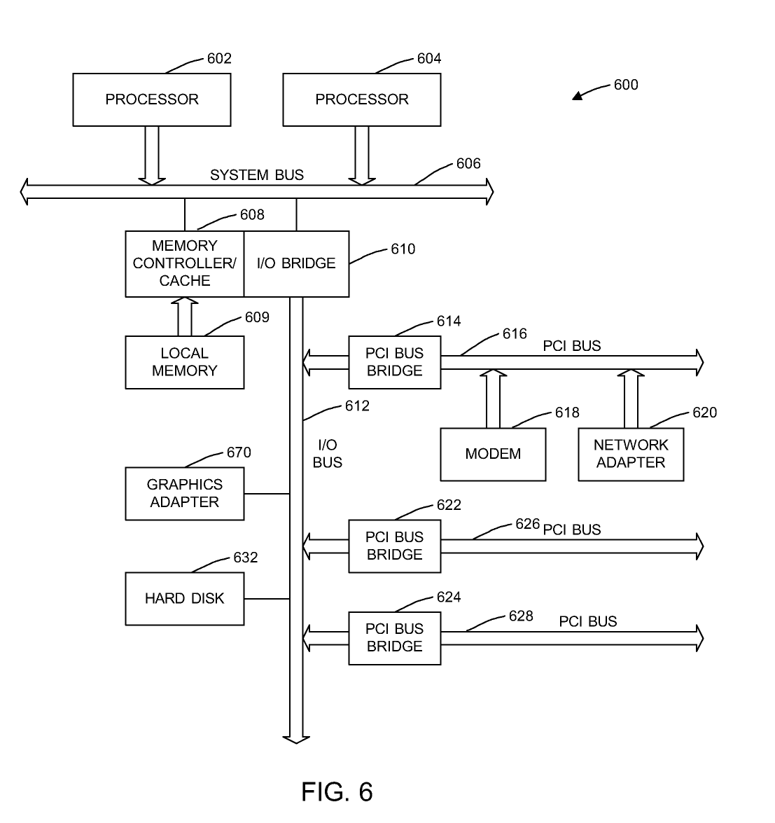

Referring to FIG. 6, a block diagram of a data processing system that may be implemented as a server, such as server a 101 in FIG. 1, is depicted in accordance with an embodiment of the present invention. Data processing system 600 may be a symmetric multiprocessor (SMP) system including a plurality of processors 602 and 604 connected to system bus 606. Alternatively, a single processor system may be employed. Also connected to system bus 606 is memory controller/cache 608, which provides an interface to local memory 609. I/O bus bridge 610 is connected to system bus 606 and provides an interface to I/O bus 612. Memory controller/cache 608 and I/O bus bridge 610 may be integrated as depicted.

Peripheral component interconnect (PCI) bus bridge 614 connected to I/O bus 612 provides an interface to PCI local bus 616. A number of modems may be connected to PCI local bus 616. Typical PCI bus implementations will support four PCI expansion slots or add-in connectors. Communications links to network 109 in FIG. 1 may be provided through modem 618 and network adapter 620 connected to PCI local bus 616 through add-in boards. Additional PCI bus bridges 622 and 624 provide interfaces for additional PCI local buses 626 and 628, respectively, from which additional modems or network adapters may be supported. In this manner, data processing system 600 allows connections to multiple network computers. A memory-mapped graphics adapter 670 and hard disk 632 may also be connected to I/O bus 612 as depicted, either directly or indirectly.

Those of ordinary skill in the art will appreciate that the hardware depicted in FIG. 6 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 6 may be, for example, an IBM eServer pSeries system, a product of International Business Machines Corporation in Armonk, N.Y., running the Advanced Interactive Executive (AIX) operating system or LINUX operating system.

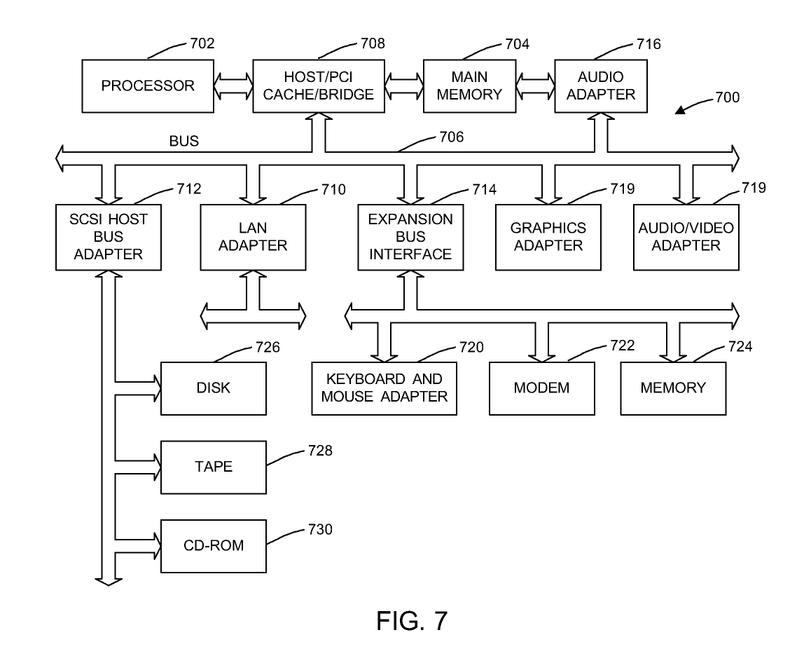

With reference now to FIG. 7, a block diagram illustrating a data processing system is depicted in which management console 111 of the present invention may be implemented. Data processing system 700 is an example of a client computer. Data processing system 700 employs a peripheral component interconnect (PCI) local bus architecture. Although the depicted example employs a PCI bus, other bus architectures such as Accelerated Graphics Port (AGP) and Industry Standard Architecture (ISA) may be used. Processor 702 and main memory 704 are connected to PCI local bus 706 through PCI bridge 708. PCI bridge 708 also may include an integrated memory controller and cache memory for processor 702. Additional connections to PCI local bus 706 may be made through direct component interconnection or through add-in boards. In the depicted example, local area network (LAN) adapter 710, Small computer system interface (SCSI) host bus adapter 712, and expansion bus interface 714 are connected to PCI local bus 706 by direct component connection. In contrast, audio adapter 716, graphics adapter 718, and audio/video adapter 719 are connected to PCI local bus 706 by add-in boards inserted into expansion slots. Expansion bus interface 714 provides a connection for a keyboard and mouse adapter 720, modem 722, and additional memory 724. SCSI host bus adapter 712 provides a connection for hard disk drive 726, tape drive 728, and CD-ROM drive 730. Typical PCI local bus implementations will support three or four PCI expansion slots or add-in connectors.

An operating system runs on processor 702 and is used to coordinate and provide control of various components within data processing system 700 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 700. “Java” is a trademark of Sun Microsystems, Inc. Instructions for the operating system, the object-oriented operating system, and applications or programs are located on storage devices, such as hard disk drive 726, and may be loaded into main memory 704 for execution by processor 702.

Those of ordinary skill in the art will appreciate that the hardware in FIG. 7 may vary depending on the implementation. Other internal hardware or peripheral devices, such as flash read-only memory (ROM), equivalent nonvolatile memory, or optical disk drives and the like, may be used in addition to or in place of the hardware depicted in FIG. 7. Also, the processes of the present invention may be applied to a multiprocessor data processing system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium or media having computer readable program code embodied thereon.

Any combination of one or more computer readable medium or media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions comprising the program code for carrying out aspects of the present invention may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the foregoing flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the foregoing flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method, which comprises:
automatically deploying a first virtual image to each of a plurality of servers in a heterogeneous system of servers;
calculating a quality of service metric for said first virtual image on each said server; and,
automatically redeploying said first virtual image to a server associated with a highest quality of service metric for said first virtual image.

2. The method as claimed in claim 1, further comprising:
examining outgoing network traffic from said first virtual image to recipient virtual images in said system of servers;
determining a recipient virtual image receiving a highest volume of outgoing network traffic from said first virtual image; and,
automatically deploying said recipient virtual image receiving said highest volume of outgoing network traffic from said first virtual image to a server located physically near the server to which said first virtual image is deployed.

3. The method as claimed in claim 2, wherein said automatically deploying said recipient image receiving said highest volume of outgoing network traffic comprises:
determining if a quality of service metric calculated for said recipient virtual image receiving said highest volume of outgoing network traffic from said first virtual image on the server to which first virtual image is deployed is acceptable; and,
if said quality of service metric calculated for said recipient virtual image receiving said highest volume of outgoing network traffic from said first virtual image on the server to which first virtual image is deployed is acceptable, deploying said recipient virtual image receiving said highest volume of outgoing network traffic from said first virtual image to the server to which said first virtual image is deployed.

4. The method as claimed in claim 1, wherein said first virtual image is associated with a range of quality of service metric values from a maximum value to a minimum value, and said method further comprises:
determining a number of servers to which said first virtual image has been deployed wherein said quality of service metric is greater than said maximum value; and,
automatically reducing resources allocated on the server to which said first virtual image is deploy to said first virtual image if said number of servers to which said first virtual image has been deployed wherein said quality of service metric is greater than said maximum value is greater than a preselected number.

5. The method as claimed in claim 4, further comprising:
monitoring performance of first virtual image after reducing said resources; and,
automatically reallocating resources to said first virtual image if said performance monitored after reducing said resources is less than said minimum quality of service metric value.

6. The method as claimed in claim 1, further comprising:
using quality of service information for said first virtual image to forecast periods in which said quality of service for said first virtual image will fall below a predetermined threshold; and,
automatically deploying additional instances of said first virtual image in anticipation of forecasted periods in which said quality of service for said first virtual image will fall below said predetermined threshold.

7. A system, which comprises:
a plurality of servers, said servers including servers having different architectures;
a network interconnecting said plurality of servers;
a management console coupled to said network, said management console including:
means for automatically deploying a first virtual image to each of a plurality of servers in a heterogeneous system of servers;
means for calculating a quality of service metric for said first virtual image on each said server; and,
means for automatically redeploying said first virtual image to a server associated with a highest quality of service metric for said first virtual image.

8. The system as claimed in claim 7, wherein said management console further includes:
means for examining outgoing network traffic from said first virtual image to recipient virtual images in said system of servers;
means for determining a recipient virtual image receiving a highest volume of outgoing network traffic from said first virtual image; and,
means for automatically deploying said recipient virtual image receiving said highest volume of outgoing network traffic from said first virtual image to a server located physically near the server to which said first virtual image is deployed.

9. The system as claimed in claim 8, wherein said means for automatically deploying said recipient image receiving said highest volume of outgoing network traffic comprises:
means for determining if a quality of service metric calculated for said recipient virtual image receiving said highest volume of outgoing network traffic from said first virtual image on the server to which first virtual image is deployed is acceptable; and,
means for deploying said recipient virtual image receiving said highest volume of outgoing network traffic from said first virtual image to the server to which said first virtual image is deployed, if said quality of service metric calculated for said recipient virtual image receiving said highest volume of outgoing network traffic from said first virtual image on the server to which first virtual image is deployed is acceptable.

10. The system as claimed in claim 7, wherein said first virtual image is associated with a range of quality of service metric values from a maximum value to a minimum value, and said system further comprises:
means for determining a number of servers to which said first virtual image has been deployed wherein said quality of service metric is greater than said maximum value; and,
means for automatically reducing resources allocated on the server to which said first virtual image is deploy to said first virtual image if said number of servers to which said first virtual image has been deployed wherein said quality of service metric is greater than said maximum value is greater than a preselected number.

11. The system as claimed in claim 10, wherein said management console further comprises:
means for monitoring performance of first virtual image after reducing said resources; and,
means for automatically reallocating resources to said first virtual image if said performance monitored after reducing said resources is less than said minimum quality of service metric value.

12. The system as claimed in claim 7, further comprising:
means for using quality of service information for said first virtual image to forecast periods in which said quality of service for said virtual image will fall below a predetermined threshold; and,
means for automatically deploying additional instances of said virtual image in anticipation of forecasted periods in which said quality of service for said virtual image will fall below said predetermined threshold.

13. A computer program product in computer readable storage medium, said computer program product comprising:
instructions stored in said computer readable storage medium for automatically deploying a first virtual image to each of a plurality of servers in a heterogeneous system of servers;
instructions stored in said computer readable storage medium for calculating a quality of service metric for said first virtual image on each said server; and,
instructions stored in said computer readable storage medium for automatically redeploying said first virtual image to a server associated with a highest quality of service metric for said first virtual image.

14. The computer program product as claimed in claim 13, further comprising:
instructions stored in said computer readable storage medium for examining outgoing network traffic from said first virtual image to recipient virtual images in said system of servers;
instructions stored in said computer readable storage medium for determining a recipient virtual image receiving a highest volume of outgoing network traffic from said first virtual image; and,
instructions stored in said computer readable storage medium for automatically deploying said recipient virtual image receiving said highest volume of outgoing network traffic from said first virtual image to a server located physically near the server to which said first virtual image is deployed.

15. The computer program product as claimed in claim 14, wherein said instructions stored in said computer readable storage medium for automatically deploying said recipient image receiving said highest volume of outgoing network traffic comprises:
instructions stored in said computer readable storage medium for determining if a quality of service metric calculated for said recipient virtual image receiving said highest volume of outgoing network traffic from said first virtual image on the server to which first virtual image is deployed is acceptable; and,
instructions stored in said computer readable storage medium for deploying said recipient virtual image receiving said highest volume of outgoing network traffic from said first virtual image to the server to which said first virtual image is deployed, if said quality of service metric calculated for said recipient virtual image receiving said highest volume of outgoing network traffic from said first virtual image on the server to which first virtual image is deployed is acceptable.

16. The method as claimed in claim 1, wherein said first virtual image is associated with a range of quality of service metric values from a maximum value to a minimum value, and said computer program product further comprises:
instructions stored in said computer readable storage medium for determining a number of servers to which said first virtual image has been deployed wherein said quality of service metric is greater than said maximum value; and,
instructions stored in said computer readable storage medium for automatically reducing resources allocated on the server to which said first virtual image is deploy to said first virtual image if said number of servers to which said first virtual image has been deployed wherein said quality of service metric is greater than said maximum value is greater than a preselected number.

17. The computer program product as claimed in claim 16, further comprising:
instructions stored in said computer readable storage medium for monitoring performance of first virtual image after reducing said resources; and,
instructions stored in said computer readable storage medium for automatically reallocating resources to said first virtual image if said performance monitored after reducing said resources is less than said minimum quality of service metric value.

18. The computer program product as claimed in claim 1, further comprising:
instructions stored in said computer readable storage medium for using quality of service information for said first virtual image to forecast periods in which said quality of service for said virtual image will fall below a predetermined threshold; and,
instructions stored in said computer readable storage medium for automatically deploying additional instances of said virtual image in anticipation of forecasted periods in which said quality of service for said virtual image will fall below said predetermined threshold.
